(19) United States
(12) Patent Application Publication
(10) Pub. No.: US 2014/0091733 A1
(43) Pub. Date: Apr. 3, 2014

(54) LIGHT EMITTING DIODE LIGHTING DEVICE WITH TUNABLE DUTY CYCLES

(71) Applicants: KUAN-HONG HSIEH, Miaoli (TW); TE-SHENG CHEN, Miaoli (TW); HSIEN-CHUNG SHIH, Miaoli (TW)

(72) Inventors: KUAN-HONG HSIEH, Miaoli (TW); TE-SHENG CHEN, Miaoli (TW); HSIEN-CHUNG SHIH, Miaoli (TW)

(21) Appl. No.: 13/771,289

(22) Filed: Feb. 20, 2013

(30) Foreign Application Priority Data
Oct. 2, 2012 (TW) 101136287

(51) Int. Cl. H05B 37/02

(52) U.S. Cl. CPC H05B 37/02
USPC 315/307

(57) ABSTRACT

This disclosure provides a smart lighting apparatus. The lighting device includes a power input device and an insertion slot. The power input device is electrically connected to a light source, and the insertion slot is installed between the light source and the power input device for receiving the smart card to manage the lighting device. The smart card has a power source and an ecosystem dimming device electrically connected with to the power source. The ecosystem dimming device controls the luminance of the light source with power-saving efficiency.

### BACKGROUND

1. Technical Field

The disclosure is related to a smart lighting apparatus, and particularly to a smart lighting apparatus with tunable luminance modulated according to the in-situ lighting requirement.

2. Description of Related Art

Efficient lighting options are replacing old fashioned energy-hungry incandescent light bulbs and halogen spotlights. One of the major options is lighting devices with light emitting diodes (LEDs). To obtain an adjustable brightness, dimmers for the LEDs are required to provide currents in a range for driving LEDs. A superior method of dimming LEDs is to use pulse width modulation (PWM). The PWM process is a convenient way to interlace a duty cycle controller with a switching converter, such as a metal-oxide-semiconductor field-effect transistor (MOSFET).

With PWM, strings of LED bulbs can all be driven with a recommended forward current, with the dimming effects achieved by turning the LEDs on and off at such high frequencies that human eyes cannot see the strobing effects. The longer the on periods, the brighter the LEDs will appear to an observer.

Lighting apparatus are used in living rooms, bedrooms, and dining rooms with different lighting requirements. The lighting requirements may be affected by location of the house, incident angles of sun light, and decoration style. However, known dimmers for lighting apparatuses available on the market are incompatible amongst different manufacturers and are incapable of meeting all the different lighting requirements for the lighting apparatuses in different areas of the house. Multi-purpose dimmers capable of meeting the various requirements for lighting and reducing energy consumptions of the lighting apparatuses are therefore desirable.

### BRIEF DESCRIPTION OF THE DRAWINGS

The components in the drawings are not necessarily drawn to scale, the emphasis instead being placed upon clearly illustrating the principles of an smart lighting apparatus with tunable duty cycles. Moreover, in the drawings, like reference numerals designate corresponding parts throughout the several views.

FIG. 1 is a schematic diagram illustrating a smart lighting apparatus according to a first embodiment of the disclosure.

FIG. 2 is a schematic diagram illustrating the smart lighting apparatus according to a second embodiment of the disclosure.

FIG. 3 is block diagram illustrating a smart card of the smart lighting apparatus tuning the luminance of a lighting device of the smart lighting apparatus.

### DETAILED DESCRIPTION

The disclosure will be described with references to the accompanying diagrams.

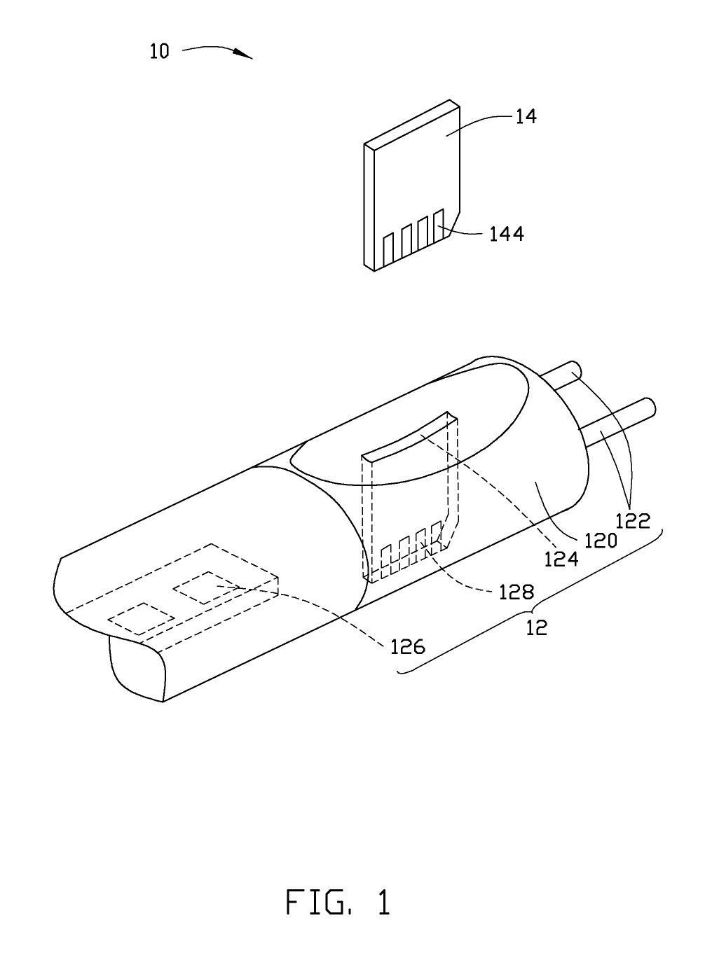

FIG. 1 shows a schematic diagram of a smart lighting apparatus 10 according to a first embodiment of the present application. The smart lighting apparatus 10 includes a lighting device 12 and a smart card 14. The lighting device 12 includes a housing 120, a power input device 122, an insertion slot 124, a light source 126, and a first electrode pad 128. The power input device 122 is electrically connected to the light source 126. The insertion slot 124 is installed between the power input device 122 and the light source 126 to receive the smart card 14 and to electrically connected the smart card 14 and the lighting device 12. In the first embodiment, the lighting device 12 is a light tube, and the insertion slot 124, the light source 126, and the first electrode pad 128 are embedded in the housing 120. The power input device 122 includes at least one electrode connected at each end of the housing 120 of the light tube. The insertion slot 124 is located near the electrodes at one end of the housing 120. The light source 126 includes an array of light emitting diodes (LEDs) electrically connected in series. The power input device 122 applies a working current to drive the light source 126 (the array of the LEDs) to generate light.

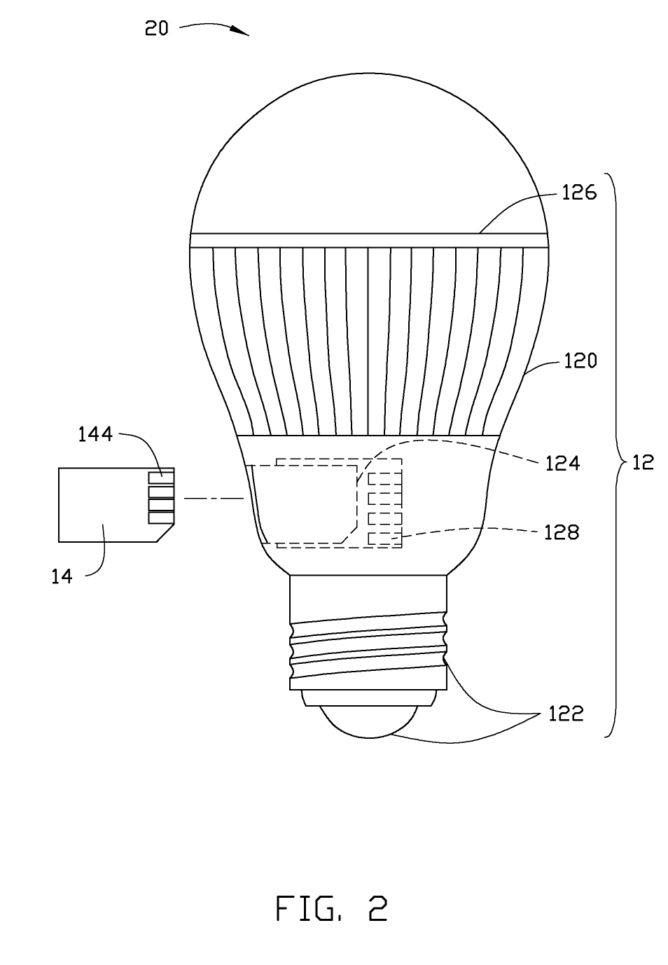

FIG. 2 shows a schematic diagram of a smart lighting apparatus 20 according to a second embodiment of the disclosure. The smart lighting apparatus 20 is similar to the smart lighting apparatus 10. Elements labeled the same in FIG 2 have similar functions. The difference between the smart lighting apparatus 10 of the first embodiment and the smart lighting apparatus 20 of the second embodiment is that the lighting device 12 is a light bulb. The power input, device 122 is the electrical contact at a bottom of a housing 120. The electrical contact includes a screw mount and an electrode located at the bottom of the screw mount. When the electrical, contact screws into a matching socket, a working current is provided through the electrical contact. The insertion slot 124 is installed in the housing 120 placed above the power input device 122. The housing 120 further has a heat sink and the light source 126 of the lighting device 12 is placed on the heat sink. In the second embodiment, the light source 126 includes at least an LED, which is driven by the working current provided by the power input device 122 to generate light.

The lighting device 12 may be a light tube (see FIG. 1), a light bulb (see FIG. 2), a lamp, or a socket. Similarly, when the lighting device 12 is the lamp or the socket, the lamp or the socket has a corresponding power input device 122 to provide a working current tor the corresponding light source 126 electrically connected to the power input device 122.

Before the smart card 14 is inserted into the insertion slot 124, the lighting device 12 generates a predetermined luminance of light powered by the working current applied by the power input device 122. The first electrode pad 128 is located corresponding to the insertion slot 124 and electrically connected to the power input device 122 and the light source 126. When the smart card 14 is inserted into the insertion slot 124, the smart card 14 contacts the first electrode pad 128 and electrically connects to the power input device 122 and the light source 126 of the lighting device 12.

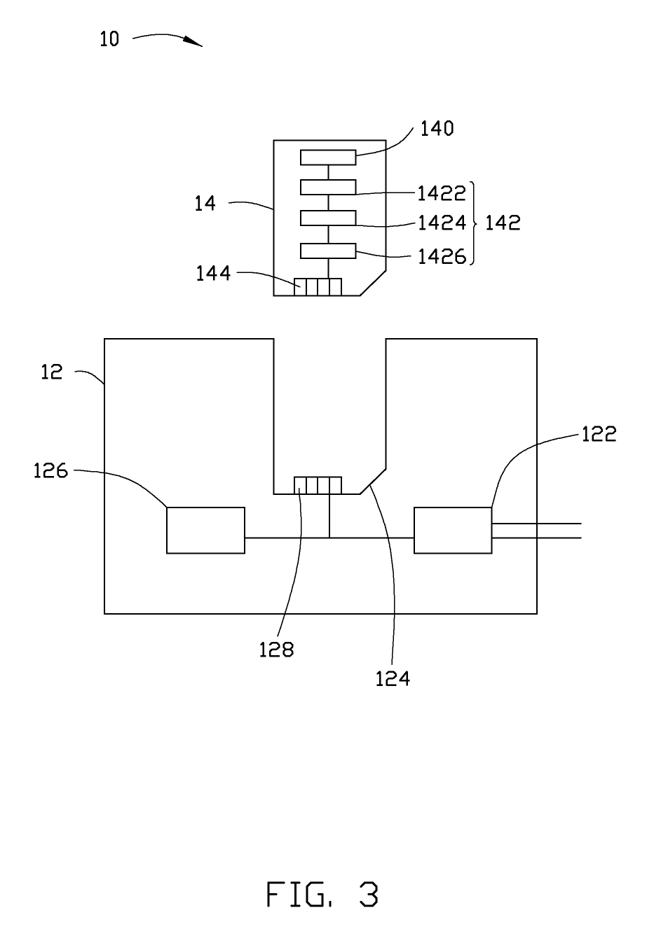

FIG. 3 is block diagram, illustrating how the smart card 14 tunes the luminance of the lighting device 12 of the smart lighting apparatus 10. The smart card 14 has a power device 140 and an ecosystem dimming device 142 electrically connected to the power device 140. The ecosystem dimming device 142 provides several programs, including an ambient light sensing dimming program 1422, a timer dimming program 1424, and an efficiency management dimming program 1426. The ambient light, sensing dimming program 1422 relies on a light sensor to detect the luminance of the ambient light and provides a result to the smart card 14. According to the result, the smart card 14 determines the working current provided for the light source 126 to generate a corresponding luminance of lights.

The timer dimming program 1424 is coded to determine the luminance of the lighting device 12 in periods according to a predetermined schedule based on user's habitual behavior or dally schedule. The efficiency management dimming program 1426 is coded to determine the luminance of the lighting device 12 according to a precision calculation to manage the household appliance in an efficient and power-saving mode.

The ecosystem dimming device 142 is powered by the power device 140 and signals from the ecosystem dimming device 142 is transmitted through a second electrode pad 144 on the smart card 14. The second electrode pad 144 is electrically connected to the ecosystem dimming device 142. When the smart card 14 is inserted into the insertion slot 124, the second electrode pad 144 is electrically connected to the first electrode pad 128 in the lighting device 12 to control the value of the working current provided by the power input device 122 to the lighting source 126 and consequently manage the luminance of the lighting device 12 efficiently.

The ecosystem dimming device 142 may be controlled by a distal remote or an in-situ controller. The distal remote refers to (but is not limited to) operate the ecosystem dimming device 142 by a phone, a computer or other communicating equipment from a far end. The in-situ controller refers to (but is not limited to) operate the ecosystem dimming device 142 by a wireless remote or a wired remote.

The smart lighting apparatus 10 of the disclosure manages the working currents for the lighting source 126 through the ecosystem dimming program 142 in the smart card 14 to determine the luminance of the smart lighting apparatus 10. Therefore, the smart fighting apparatus 10 is operated efficiently to enhance performance and energy-saving.

It is to be understood, however, that even though numerous characteristics and advantages of the present embodiments have been set fourth in the foregoing description, together with details of the structures and functions of the embodiments, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A smart lighting apparatus, comprising:
a lighting device, the lighting device comprising:
a light source;
a power input device electrically connected to the light source; and
an insertion slot installed between the power input device and the light source; and
a smart card configured to be inserted into the insertion slot and to electrically connect with the lighting device, the smart card comprising:
a power source; and
an ecosystem dimming device electrically connected to the power source and capable of tuning luminance of the light source.

2. The smart lighting apparatus as claim 1, wherein the power input device is adapted to supply a working current to generate light of a luminance corresponding to the working current by the light source.

3. The smart lighting apparatus as claim 1, wherein the insertion slot comprises a first electrode pad which is electrically connected to the light source.

4. The smart lighting apparatus as claim 3, wherein the smart card comprises a second electrode pad electrically connected to the ecosystem dimming device, and the second electrode pad is electrically connected to the first electrode pad when the smart card is inserted into the insertion slot.

5. The smart lighting apparatus as claim 1, wherein the ecosystem dimming device comprising an ambient light sensing dimming program, a timer dimming program, and a efficiency management dimming program.

6. The smart lighting apparatus as claim 5, wherein the ambient light sensing dimming program determines a value of the working current supplied by the power input device according to a result provided by a light sensor which detects the ambient light.

7. The smart lighting apparatus as claim 6, wherein the timer dimming program is determined by a predetermined schedule to manage luminance of the smart Sighting apparatus.

8. The smart lighting apparatus as claim 1, wherein the lighting device comprises a light tube, a light bulb, a lamp, or a socket.

9. The smart lighting apparatus as claim 8, wherein the lighting device is a light tube comprising an array of light emitting diodes (LEDs) electrically connected in serial, the power input device comprises at least one electrode, the at least one electrode being configured to be connected to the light tube at each, end of a housing of the light time, the insertion slot is installed near the at least one electrode at one end.

10. The smart lighting apparatus as claim 8, wherein the lighting device is a light bulb comprising at least one LED, the power input device comprises an electrical contact, the insertion slot is Installed in a housing of the light bulb and above the electrical contact.
